(19) United States
(12) Patent Application Publication
(10) Pub. No.: US 2007/0069173 A1
(43) Pub. Date: Mar. 29, 2007

(54) High pressure ball valve seal assembly

(76) Inventors: James R. Zachman, The Woodlands, TX (US); Stephen L. Crow, Kingwood, TX (US); Steven Hayter, Houston, TX (US)

Correspondence Address: DUANE MORRIS LLP, 3200 SOUTHWEST FREEWAY, SUITE 3150, HOUSTON, TX, 77027, US

(21) Appl. No.: 11/521,283

(22) Filed: Sep. 14, 2006

Related U.S. Application Data
(60) Provisional application No. 60/722,660, filed on Sep. 29, 2005.

(51) Int. Cl. F16K 5/06

(52) U.S. Cl. 251/315.16

(57) ABSTRACT

A ball design for withstanding high differential pressures without leakage features a circumferential groove near the circle of contact on the ball with a surrounding seat. High differential forces are transmitted beyond the circle of contact so that deflection due to applied differential pressures results in flexing in the groove area while maintaining full circumferential seat contact to prevent leakage.

### PRIORITY INFORMATION

This application claims the benefit of U.S. Provisional Application No. 60/722,660, filed on Sep. 29, 2005.

### FIELD OF THE INVENTION

The field of this invention is ball valves and more particularly ball valves for downhole use that seal against high differential pressures.

### BACKGROUND OF THE INVENTION

Ball valves have a variety of applications in many industries and are also commonly used for zone isolation and fluid loss prevention services. These valves typically house a ball in a housing wherein the housing features a seat above and below the ball that is spring loaded or otherwise biased against the ball when the ball is rotated to the valve closed position. FIGS. 1 and 2 schematically illustrate the problem in the prior art designs when the ball is subjected to applied differential pressure in one of two opposed directions. FIG. 1 shows a ball 10 having a passage 12 that is close to the size of the inlet and outlet to the housing for the ball 10, which is omitted from the drawing for greater clarity. A seat 14 has a bias 16 applied in a direction toward the ball 10. The ball 10 is in the closed position in FIG. 1 as the passage 12 is rotated away from seat 14 so that a blank solid portion 18 is engaged to the seat 14 with the bias 16 pushing the two together to enhance the seal. Ball 10 has truncated straight sides 20 and 22 to allow connection of operators (not shown) that can rotate it 90 degrees in opposed directions between the open and the closed positions. As can be seen in FIG. 1, the ball is thicker and therefore stronger nearer sides 20 and 22. However near the center 24, there is considerably less material and the ball structure is relatively weaker. FIG. 2 illustrates what happens under high pressure differentials because of the inherent structure of the ball 10. The portion near the center 24 in the closed position and under applied differential pressure 26 deflects at 28 and separates from the seat 14 to permit leakage.

The present invention addresses this issue of deflection at the thin portion of the ball 10 under high differential pressures with a simple and effective solution that simply allows compensation for the deflection where separation from the seat 14 will not happen. These and other advantages of the present invention will be more readily apparent to those skilled in the art from a review of the detailed description of the preferred embodiment that appears below.

### SUMMARY OF THE INVENTION

A ball design for withstanding high differential pressures without leakage features a circumferential groove near the circle of contact on the ball with a surrounding seat. High differential forces are transmitted beyond the circle of contact so that deflection due to applied differential pressures results in flexing in the groove area while maintaining full circumferential seat contact to prevent leakage.

### BRIEF DESCRIPTION OF THE DRAWINGS

FIG. 1 is a schematic view of a prior art ball of a ball valve in the closed position before differential pressure exists;

FIG. 2 is the view of FIG. 1 with applied differential pressure causing flexing near the center of the ball and a separation from the adjacent seat;

FIG. 3 is a schematic view of the ball of the present invention in the closed position before differential pressure is applied;

FIG. 4 is the view of FIG. 3 with differential pressure applied and showing the groove flexing away from the seat area to help maintain full 360 degree contact with the seat.

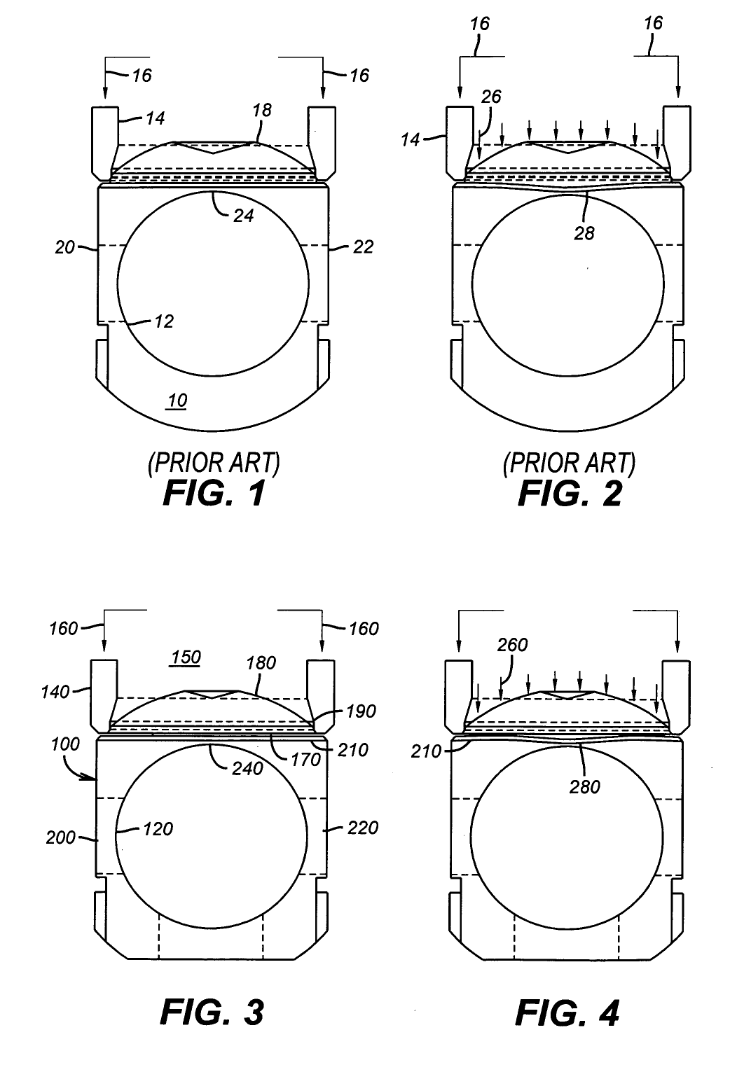

### DETAILED DESCRIPTION OF THE PREFERRED EMBODIMENT

FIG. 3 shows the ball 100 having a passage 120 and opposed flat sides 200 and 220 for the same purpose as previously described. A seat 140 is under a bias force 160. The solid portion 180 of the ball 100 makes a full 360 degree contact with the seat 140 to isolate a passage 150. In the present invention, the ball 100 has a peripheral groove 170 that is disposed between the circle of contact of the ball 100 with the seat 140 and above the passage 120. Groove 170 can have a uniform or varying cross sectional shape. It can be continuous or discontinuous over the circumference. The opposing walls 190 and 210 can taper away from each other toward the outer surface of the ball 100 so as not to contact each other when deflection 280 of surface 210 occurs under differential pressure loading 260. Under loading, the surface 180 deflects uniformly maintaining 360 degree contact with the seat 140 because the support for the seat 140 on the surface 180 is equalized. The balance of the load from the applied differential pressure 260 is transferred through the ball to the bottom of the groove 170 at surface 210 which deflects 280 in response to that load. However the deflection does not result in separation between the surface 180 and the seat 140.

Those skilled in the art will appreciate that the present invention provides a mechanism for distancing the anticipated deflection to a point beyond the sealing contact of the ball surface to the surrounding seat. It provides recognition of the cause of a problem that has undermined sealing integrity in the past and proposes generally a solution of a mechanism to tolerate deflection but to make it an inconsequential event that does not undermine sealing integrity on the seat. The distancing of the deflection does not reduce the size of the ball passage. An alternate approach to addressing the problem could be by making the ball thicker at the presently anticipated deflection location. While that technique can conceivably result in sealing integrity at the seat under high differential pressures, it may result in a decrease of the passage diameter through the ball to achieve it.

We claim:

1. A ball valve, comprising:
a body having a passage therethrough;
a ball rotatably mounted in said passage and having a bore therethrough selectively aligned with said passage and solid segments straddling said bore and alternatively selectively aligned with said passage to close said valve;
said body further comprising at least one seal to engage at least one of said solid segments in a contact location for sealing differential pressure across said solid segment;
said contact location configured to deflect substantially uniformly under differential pressure loading so as to maintain contact with said seal.

2. The valve of claim 1, wherein:
said ball further comprises an outer surface on which said contact occurs and a gap on said outer surface located on a side opposite said contact location from the source of differential pressure.

3. The valve of claim 2, wherein:
said gap is continuous.

4. The valve of claim 2, wherein:
said gap is not continuous.

5. The valve of claim 2, wherein:
said gap is wide enough so that deflection of said contact location does not close said gap.

6. The valve of claim 2, wherein:
said gap comprises opposed surfaces further comprising a first surface closer to said contact location and a second surface further away from said contact location than said first surface, whereupon said uniform deflection at said contact location, said second surface additionally deflects.

7. The valve of claim 6, wherein:
said second surface deflects in a location substantially in alignment with a center of said bore.

8. The valve of claim 2, wherein:
said contact location is substantially circular.

9. The valve of claim 6, wherein:
said first and second surfaces are parallel.

10. The valve of claim 6, wherein:
said first and second surfaces are not parallel.

11. The valve of claim 2, wherein:
the cross-sectional area of said gap is uniform.

12. The valve of claim 2, wherein:
the cross-sectional area of said gap is not uniform.

13. The valve of claim 3 wherein:
the shape of said gap is circular.

14. The valve of claim 13 wherein:
said contact location is substantially circular.

15. The valve of claim 14 wherein:
said gap comprises opposed surfaces further comprising a first surface closer to said contact location and a second surface further away from said contact location than said first surface, whereupon said uniform deflection at said contact location, said second surface additionally deflects.

16. The valve of claim 15 wherein:
said second surface deflects in a location substantially in alignment with a center of said bore.

17. The valve of claim 16 wherein:
said first and second surfaces are parallel.

18. The valve of claim 17 wherein:
the cross-sectional area of said gap is uniform.
